(19) United States
(12) Patent Application Publication
(10) Pub. No.: US 2025/0132311 A1
(43) Pub. Date: Apr. 24, 2025

(54) NEGATIVE ELECTRODE ACTIVE MATERIAL FOR NONAQUEOUS ELECTROLYTE SECONDARY BATTERY, AND NONAQUEOUS ELECTROLYTE SECONDARY BATTERY

(71) Applicant: Panasonic Energy Co., Ltd., Moriguchi-shi, Osaka (JP)

(72) Inventor: Isao Koizumi, Osaka (JP)

(73) Assignee: Panasonic Energy Co., Ltd, Moriguchi-shi, Osaka (JP)

(21) Appl. No.: 18/694,550

(22) PCT Filed: Jun. 28, 2022
(86) PCT No.: PCT/JP2022/025674

§ 371 Date: Mar. 22, 2024

(30) Foreign Application Priority Data
Sep. 30, 2021 (JP) 2021-160760

(51) Int. Cl. H01M 4/36; H01M 4/02; H01M 4/48; H01M 4/583

(52) U.S. Cl. CPC H01M 4/364; H01M 4/483; H01M 4/583; H01M 2004/021; H01M 2004/027

(57) ABSTRACT

This negative electrode active material for a nonaqueous electrolyte secondary battery is characterized: by comprising a silicate-containing complex having a carbon phase and a plurality of Si-containing silicate particles dispersed in the carbon phase; and in that the Si-containing silicate particles each have a silicate phase and a plurality of silicon particles dispersed in the silicate phase, and the ratio (B/A) of the average particle diameter (B) of the silicate-containing complex with respect to the average particle diameter (A) of the Si-containing silicate particles is 15-120 inclusive.

### TECHNICAL FIELD

The present disclosure relates to a negative electrode active material for a non-aqueous electrolyte secondary battery and a non-aqueous electrolyte secondary battery.

### BACKGROUND

In recent years, since a non-aqueous electrolyte secondary battery has a high voltage and a high energy density, the non-aqueous electrolyte secondary battery is expected as a power source for a small consumer application, a power storage device, and an electric vehicle. As a battery is required to have a higher energy density, use of a material containing silicon to be alloyed with lithium is expected as a negative electrode active material having a high theoretical capacity density.

For example, Patent Literatures 1 and 2 disclose a negative electrode active material for a non-aqueous electrolyte secondary battery containing composite particles including silicon particles and a carbon phase covering surfaces of the silicon particles.

In addition, for example, Patent Literature 3 discloses a negative electrode active material for a non-aqueous electrolyte secondary battery containing composite particles having a graphite substrate and a nano-silicon material deposited inside the graphite substrate.

In addition, for example, Patent Literature 4 discloses a negative electrode active material for a non-aqueous electrolyte secondary battery containing composite particles containing a lithium silicate phase and silicon particles dispersed in the lithium silicate phase.

In addition, for example, Patent Literature 5 discloses a negative electrode active material for a non-aqueous electrolyte secondary battery containing composite particles having a configuration in which scaly silicon particles are dispersed in a carbon material, and graphite-based particles.

### CITATION LIST

### PATENT LITERATURES

Patent Literature 1: JP 2000-272911 A
Patent Literature 2: JP 2000-21588 7 A
Patent Literature 3: JP1 6367781 B
Patent Literature 4: WO 2018/101072 A
Patent Literature 5: JP 2019-67579 A

### SUMMARY

### Technical Problem

Since the silicon particles have a large volume change associated with charging and discharging, particle breakage occurs in the negative electrode active material containing the silicon particles, and the negative electrode active material is likely to be electrically isolated from the negative electrode. In addition, particle breakage may be accelerated by a decomposition product generated by a side reaction between the silicon particles and the non-aqueous electrolyte. Due to such particle breakage of the negative electrode active material and further electrical isolation of the negative electrode active material caused by the particle breakage, there is a problem that charge and discharge cycle characteristics of the non-aqueous electrolyte secondary battery are significantly deteriorated. By dispersing the silicon particles in the carbon phase or the silicate phase to form a complex as in the above-described patent literatures, particle breakage is suppressed, and deterioration of charge and discharge cycle characteristics is suppressed, but there is room for further improvement.

Therefore, an object of the present disclosure is to suppress deterioration of charge and discharge cycle characteristics of a non-aqueous electrolyte secondary battery using a negative electrode active material containing silicon particles.

### Solution to Problem

According to an aspect of the present disclosure, a negative electrode active material for a non-aqueous electrolyte secondary battery contains a silicate-containing complex containing a carbon phase and a plurality of Si-containing silicate particles dispersed in the carbon phase, in which the Si-containing silicate particle contains a silicate phase and a plurality of silicon particles dispersed in the silicate phase, and a ratio (B/A) of an average particle diameter (B) of the silicate-containing complex to an average particle diameter (A) of the Si-containing silicate particles is greater than or equal to 15 and less than or equal to 120.

According to an aspect of the present disclosure, a non-aqueous electrolyte secondary battery includes a negative electrode including a negative electrode mixture layer containing the negative electrode active material for a non-aqueous electrolyte secondary battery, a positive electrode, and a non-aqueous electrolyte.

### Advantageous Effects of Invention

According to an aspect of the present disclosure, it is possible to suppress deterioration of charge and discharge cycle characteristics of a non-aqueous electrolyte secondary battery using a negative electrode active material containing silicon particles.

### BRIEF DESCRIPTION OF DRAWINGS

FIG. 1 is a schematic cross-sectional view of a silicate-containing complex as an example of an embodiment.

FIG. 2 is a schematic cross-sectional view of a Si-containing silicate particle constituting the silicate-containing complex.

### DESCRIPTION OF EMBODIMENTS

According to an aspect of the present disclosure, a negative electrode active material for a non-aqueous electrolyte secondary battery contains a silicate-containing complex containing a carbon phase and a plurality of Si-containing silicate particles dispersed in the carbon phase, in which the Si-containing silicate particle contains a silicate phase and a plurality of silicon particles dispersed in the silicate phase, and a ratio (B/A) of an average particle diameter (B) of the silicate-containing complex to an average particle diameter (A) of the Si-containing silicate particles is greater than or equal to 15 and less than or equal to 120. As described above, the silicon particles are dispersed in the silicate phase to form a complex, such that a volume change of the silicon particles caused by charging and discharging and particle breakage of the negative electrode active material caused by a side reaction between the silicon particles and the non-aqueous electrolyte are suppressed. In addition, composite particles are obtained by dispersing silicon particles in a silicate phase and the composite particles are further dispersed in a carbon phase to form a complex, such that the particle breakage is suppressed, and electrical isolation of the negative electrode active material from the negative electrode, which is caused by the particle breakage, is suppressed, and therefore, deterioration of the charge and discharge cycle characteristics is suppressed.

Hereinafter, examples of embodiments will be described in detail.

The non-aqueous electrolyte secondary battery as an example of an embodiment includes a negative electrode, a positive electrode, and a non-aqueous electrolyte. A separator is preferably provided between the positive electrode and the negative electrode. An example of a structure of the non-aqueous electrolyte secondary battery is a structure in which an electrode assembly formed by winding a positive electrode and a negative electrode with a separator interposed therebetween and a non-aqueous electrolyte are housed in an exterior body. Alternatively, instead of the wound electrode assembly, another form of an electrode assembly such as a stacked electrode assembly in which a positive electrode and a negative electrode are stacked with a separator interposed therebetween may be applied. The non-aqueous electrolyte secondary battery may have any form such as a cylindrical type, a square type, a coin type, a button type, or a laminate type.

### [Positive Electrode]

The positive electrode preferably includes, for example, a positive electrode current collector formed of a metal foil or the like and a positive electrode mixture layer formed on the current collector. As the positive electrode current collector, a foil of a metal stable in a potential range of the positive electrode, such as aluminum, a film in which the metal is disposed on a surface layer, or the like can be used. The positive electrode mixture layer preferably contains a conductive agent and a binder in addition to the positive electrode active material.

Examples of the positive electrode active material include lithium transition metal oxides containing transition metal elements such as Co, Mn, and Ni. The lithium transition metal oxide is, for example, LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, or Li₂MPO₄F (M; at least one of Na, Mg, Sc, Y, Mn, Fe, Co, Ni, Cu, Zn, Al, Cr, Pb, Sb, and B, 0≤x≤1.2, 0<y≤0.9, 2.0≤z≤2.3). These lithium transition metal oxides may be used alone or in combination of a plurality of kinds thereof.

Examples of the conductive agent include carbon materials such as carbon black, acetylene black, Ketjenblack, and graphite. These conductive agents may be used alone or in combination of two or more thereof.

As the conductive agent, a fluorine-based resin such as polytetrafluoroethylene (PTFE) or polyvinylidene fluoride (PVdF), polyacrylonitrile (PAN), a polyimide-based resin, an acrylic resin, a polyolefin-based resin, carboxymethyl cellulose (CMC) or a salt thereof (CMC-Na, CMC-K, CMC-NH₄, or a partially neutralized salt may also be used), styrene-butadiene rubber (SBR), polyacrylic acid (PAA) or a salt thereof (PAA-Na, PAA-K, or a partially neutralized salt may also be used), polyvinyl alcohol (PVA), polyethylene oxide (PEO), or the like can be used. These binders may be used alone or in combination of two or more thereof.

### [Negative Electrode]

The negative electrode preferably includes, for example, a negative electrode current collector formed of a metal foil or the like and a negative electrode mixture layer formed on the current collector. As the negative electrode current collector, a foil of a metal stable in a potential range of the negative electrode, such as copper, a film in which the metal is disposed on a surface layer, or the like can be used.

The negative electrode mixture layer contains a negative electrode active material. The negative electrode active material contains a silicate-containing complex described below. The negative electrode mixture layer preferably contains a binder in addition to the negative electrode active material. As the binder, as in the case of the positive electrode, a fluorine-based resin, PAN, a polyimide-based resin, an acrylic resin, a polyolefin-based resin, CMC or a salt thereof (CMC-Na, CMC-K, CMC-NH₄, or a partially neutralized salt may also be used), styrene-butadiene rubber (SBR), polyacrylic acid (PA) or a salt thereof (PAA-Na, PAA-K, or a partially neutralized salt may also be used), polyvinyl alcohol (PVA), polyethylene oxide (PEO), or the like can be used.

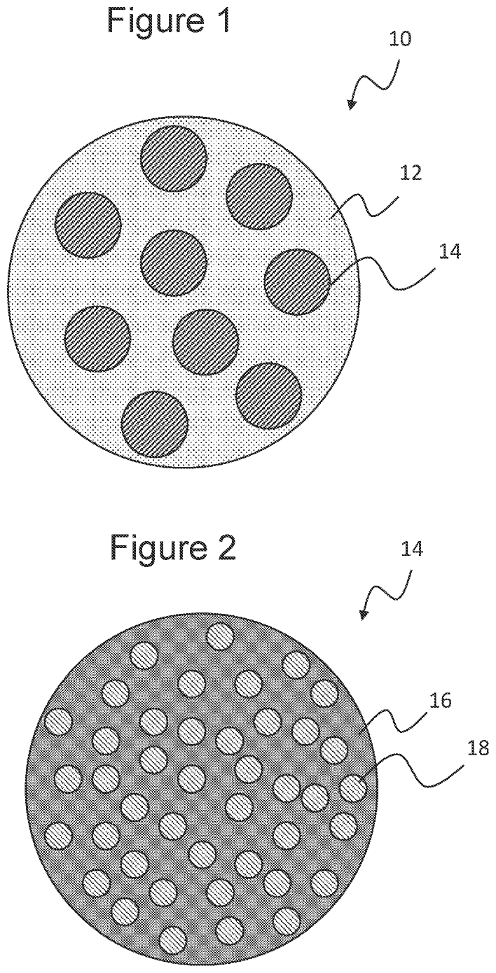

FIG. 1 illustrates a schematic cross-sectional view of a silicate-containing complex as an example of an embodiment, and FIG. 2 illustrates a schematic cross-sectional view of a Si-containing silicate particle constituting the silicate-containing complex. As illustrated in FIG. 1, a silicate-containing complex 10 contains a carbon phase 12 and a plurality of Si-containing silicate particles 14 dispersed in the carbon phase 12. The silicate-containing complex 10 has a sea-island structure in which the plurality of Si-containing silicate particles 14 are dispersed in a matrix of the carbon phase 12.

The carbon phase 12 is preferably composed of amorphous carbon. When the carbon phase 12 is composed of amorphous carbon, adhesion between the carbon phase 12 and the Si-containing silicate particles 14 can be improved, and a packing density can be improved. As a result, conductivity of the Si-containing silicate particles 14 is secured, and the side reaction between Si and the non-aqueous electrolyte is suppressed, such that the deterioration of the charge and discharge cycle characteristics is further suppressed. The carbon phase 12 may contain crystalline carbon such as graphite, but a content of the crystalline carbon is preferably less than or equal to 5 mass % and preferably less than or equal to 1 mass % with respect to a total amount of the carbon phase 12.

A content of the carbon phase 12 is preferably greater than or equal to 10 mass % and less than or equal to 45 mass % with respect to a total amount of the silicate-containing complex 10. In a case where the content of the carbon phase 12 satisfies the above range, for example, the conductivity of the Si-containing silicate particles 14 is sufficiently secured as compared with a case where the content is less than 10 mass %, such that deterioration of charge and discharge cycle characteristics may be further suppressed. In addition, in a case where the content of the carbon phase 12 satisfies the above range, the packing density of the Si-containing silicate particles 14 is improved as compared with the case of greater than 45 mass %, and the capacity of the non-aqueous electrolyte secondary battery may be increased.

A method for preparing the silicate-containing complex 10 will be described below, but the carbon phase 12 is obtained from an organic compound (carbon precursor) that can be changed to be carbonaceous by heat treatment. Examples of the carbon precursor include pitch produced by thermally decomposing an organic compound such as crude oil pitch, coal tar pitch, asphalt-decomposed pitch, or polyvinyl chloride, and synthetic pitch produced by polymerizing naphthalene or the like in the presence of a super-strong acid. In addition, a synthetic polymer such as a phenol resin polyvinyl chloride, polyvinyl alcohol, polyvinyl acetate, or polyvinyl butyral, a natural polymer such as starch or cellulose, and the like may be used.

As illustrated in FIG. 2, the Si-containing silicate particle 14 includes a silicate phase 16 and a plurality of silicon particles 18 dispersed in the silicate phase 16. It is desirable that the plurality of silicon particles 18 are substantially uniformly dispersed in the silicate phase 16. The Si-containing silicate particle 14 has, for example, a sea-structure in which the plurality of fine silicon particles 18 are dispersed in a matrix of the silicate phase 16.

The Si-containing silicate particle 14 may contain a third component in addition to the silicate phase 16 and the silicon particles 18. For example, the silicate phase 16 may contain crystalline or amorphous SiO₂ in addition to lithium silicate. A content of SiO₂ in the Si-containing silicate particle 14 measured by Si-NMR is, for example, preferably less than or equal to 30 mass %, and more preferably less than or equal to 7 mass %.

Since the silicon particles 18 can occlude more lithium ions than a carbon material such as graphite, application thereof to a negative electrode active material contributes to a high capacity of a battery. A content of the silicon particles 18 (elemental Si) in the Si-containing silicate particle 14 measured by Si-NMR is, for example, preferably greater than or equal to 20 mass % and less than or equal to 95 mass %, and more preferably greater than or equal to 35 mass % and less than or equal to 75 mass %, from the viewpoint of increasing the capacity. As a result, a high charge and discharge capacity can be secured, diffusion of lithium ions becomes preferable, and excellent load characteristics can be easily obtained.

The silicate phase 16 contains, for example, lithium silicate represented by the formula Li₂Si₂O₅·(x−2)SiO₂, LiO·2SiO₂·(x−2)SiO₂ or Li₂O·xSiO₂ (2<x≤18). Such lithium silicate is desirably contained in an amount of greater than or equal to 90 mass % in the silicate phase 16. The silicate phase 16 desirably contains a small amount of Li₄SiO₄ and Li₂SiO₃ from which an alkali component is easily eluted.

The formula: Li₂Si₂O₅·(x−2)SiO₂ preferably satisfies 2.1≤x≤18, and more preferably satisfies 3≤x≤8, from the viewpoint of stability, ease of production, lithium ion conductivity, and the like. In this case, in the silicate phase 16, in addition to the phase of Li₂Si₂O₅, phases such as Li₂Si₃O₇, Li₂Si₄O₉, Li₂Si₅O₁₁, Li₂Si₅O₁₃, Li₂Si₇O₁₅, Li₂Si₈O₁₇, Li₂Si₈O₁₉, and Li₂Si₁₀O₂₁ are delocalized, and the above composition indicates an average composition of the whole including crystal and amorphous. Among them, it is preferable to contain a phase of Li₂Si₂O₅ as a main component (component having the largest mass), and a content of Li₂Si₂O₅ in the silicate phase 16 as measured by Si-NMR is preferably greater than 15 mass % and more preferably greater than or equal to 40 mass %. Hereinafter, desirable measurement conditions of Si-NMR are shown.

### <Si-NMR Measurement Conditions>

Measuring apparatus: solid nuclear magnetic resonance spectrometer (INOVA-400) manufactured by Varian, Inc.
Probe: Vatrian 7 mm CPMAS-2
MAS: 4.2 kHz
MAS rate: 4 kHz
Pulse: DD (45° pulse+signal fetch time 1H decoupled)
Repeat time: 1,200 sec
Observation width: 100 kHz
Observation center: around −100 ppm
Signal fetch time: 0.05 sec
Number of integrations: 560
Sample amount: 207.6 mg

A composition of the silicate phase 16 can be analyzed as follows.

First, the mass of the sample of the silicate-containing complex 10 is measured. Thereafter, contents of carbon, lithium, and oxygen contained in the sample are calculated as follows. Next, the content of carbon is subtracted from the mass of the sample, the content of lithium and oxygen in the remaining amount is calculated, and an x value is determined from a molar ratio of lithium (Li) and oxygen (O).

The content of carbon is measured using a carbon/sulfur analyzer (for example, EMIA-520, manufactured by HORIBA, Ltd.). A sample is weighed and taken out from a magnetic board, a combustion aid is added to the sample, the sample is inserted into a combustion furnace (carrier gas: oxygen) heated to 1,350° C., and the amount of carbon dioxide gas generated during combustion is detected by infrared absorption. A calibration curve is prepared using, for example, carbon steel (carbon content: 0.49%) manufactured by Bureau of Analysed Sampe. Ltd., and the content of carbon of the sample is calculated (high frequency induction furnace combustion-infrared absorption method).

The content of nitrogen is measured using an oxygen/nitrogen/hydrogen analyzer (for example, EGMA-830, manufactured by HORIBA, Ltd.). A sample is placed in a Ni capsule, and charged into a carbon crucible heated at a power of 5.75 kW together with Sn pellets and Ni pellets to be a flux, and released carbon monoxide gas is detected. A calibration curve is prepared using a standard sample Y₂O₃, and the content of oxygen of the sample is calculated (inert gas fusion-non-dispersive infrared absorption method).

The content of lithium is measured by fully dissolving a sample with heated fluoronitric acid (a mixed acid of heated hydrofluoric acid and nitric acid), removing carbon of a dissolved residue by filtration and then analyzing the obtained filtrate by inductively coupled plasma atomic emission spectroscopy (ICP-AES), A calibration curve is prepared using a commercially available standard solution of lithium, and a content of lithium of the sample is calculated.

In the present embodiment, the ratio (B/A) of the average particle diameter (B) of the silicate-containing complex 10 to the average particle diameter (A) of the Si-containing silicate particles 14 is greater than or equal to 15 and less than or equal to 120, and preferably greater than or equal to 20 and less than or equal to 120. When B/A satisfies the above range, the Si-containing silicate particles 14 can be dispersed in the carbon phase 12 without being exposed from a surface of the carbon phase 12, and thus, for example, electrical isolation of the negative electrode active material from the negative electrode caused by particle breakage is suppressed, and deterioration of the charge and discharge cycle characteristics of the non-aqueous electrolyte secondary battery is suppressed.

The average particle diameter of the silicate-containing complex 10 is preferably greater than or equal to 4 μm and less than or equal to 15 μm, and more preferably greater than or equal to 4 μm and less than or equal to 8 μm. When the average particle diameter of the silicate-containing complex 10 satisfies the above range, compared to a case where the above range is not satisfied, the Si-containing silicate particles 14 can be easily dispersed in the carbon phase 12 without being exposed from the surface of the carbon phase 12, and thus, for example, electrical isolation of the negative electrode active material from the negative electrode caused by particle breakage may be suppressed, and deterioration of the charge and discharge cycle characteristics of the non-aqueous electrolyte secondary battery may be further suppressed. The average particle diameter of the silicate-containing complex 10 means a particle diameter (volume average particle diameter) at which a volume integrated value is 50% in a particle size distribution measured by a laser diffraction scattering method. As a measuring apparatus, for example, “LA-750” manufactured by HORIBA, Ltd. can be used.

The average particle diameter of the Si-containing silicate particles 14 is preferably less than or equal to 1 μm, and more preferably less than or equal to 200 nm. When the average particle diameter of the Si-containing silicate particles 14 satisfies the above range, compared to a case where the above range is not satisfied, the Si-containing silicate particles 14 can be easily dispersed in the carbon phase 12 without being exposed from the surface of the carbon phase 12, and thus, for example, electrical isolation of the negative electrode active material from the negative electrode caused by particle breakage may be suppressed, and deterioration of the charge and discharge cycle characteristics of the non-aqueous electrolyte secondary battery may be further suppressed. The average particle diameter of the Si-containing silicate particles 14 means a volume average particle diameter similarly to the silicate-containing complex 10.

An average particle diameter of the silicon particles 18 is less than or equal to 500 nm, preferably less than or equal to 200 nm, and more preferably less than or equal to 50 nm before charging and discharging. When the average particle diameter of the silicon particles 18 satisfies the above range, compared to a case where the above range is not satisfied, a volume change during charging and discharging is reduced and particle breakage is suppressed, or the silicon particles 18 are not exposed from the surface of the silicate phase 16 and are easily dispersed in the silicate phase 16, and thus, for example, a side reaction between the non-aqueous electrolyte and the silicon particles 18 can be suppressed. The average particle diameter of the silicon particles 18 is measured by observing a cross section of the silicate-containing complex 10 using a scanning electron microscope (SEM) or a transmission electron microscope (TEM), and is specifically determined by converting individual areas of 100 silicon particles 18 into equivalent circle diameters and averaging the equivalent circle diameters.

As the negative electrode active material for a non-aqueous electrolyte secondary battery, only the silicate-containing complex 10 may be used alone, or may be used in combination with other active materials. A content of the silicate-containing complex 10 is, for example, preferably greater than or equal to 1 mass % and less than or equal to 50 mass %, and more preferably greater than or equal to 10 mass % and less than or equal to 45 mass %, with respect to a total amount of the negative electrode mixture layer, in terms of increasing the capacity of the battery while suppressing deterioration of the charge and discharge cycle characteristics. As the other active materials, for example, a carbon material such as graphite is preferable. In a case where a carbon material is used in combination, a ratio of the silicate-containing complex 10 to the carbon material is preferably 1:99 to 30:70 in terms of mass ratio from the viewpoint of increasing the capacity, suppressing deterioration of the charge and discharge cycle characteristics, and the like.

An example of a method for preparing the silicate-containing complex 10 will be described.

(1) A silicate powder is prepared. For example, silicon dioxide and a lithium compound are mixed at a predetermined mass ratio, and the mixture is heated at higher than or equal to 400° C. and lower than or equal to 1,200° C. in air to obtain a silicate powder represented by the formula: Li₂Si₂O₅·(x−2)SiO₂, Li₂O·2SiO₂(x−2)SiO₂, or Li₂O·xSiO₂ (2<x≤18). In addition, it is desirable to pulverize the obtained silicate powder to a predetermined particle diameter.

(2) The silicate powder and the silicon powder are compounded. For example, the silicate powder and the silicon powder are mixed at a predetermined mass ratio, the mixture is stirred in an inert atmosphere using a pulverizer such as a planetary ball mill to compound the silicate powder and the silicon powder (compounding treatment), thereby obtaining Si-containing silicate particles. A time for the compounding treatment may be, for example, longer than or equal to 3 hours and shorter than or equal to 15 hours.

(3) The Si-containing silicate particles are pulverized and classified by an air flow classifier.

(4) The Si-containing silicate particles and a carbon precursor (for example, pitches, resins, thermally decomposable carbon gas, and the like) as a carbon phase raw material are stirred in an inert atmosphere using a pulverizer such as a planetary ball mill. A stirring time may be, for example, longer than or equal to 30 minutes and shorter than or equal to 3 hours.

(5) The mixture after stirring is heated, for example, at higher than or equal to 450° C. and lower than or equal to 1,000° C. in an inert atmosphere and fired to obtain a silicate-containing complex. At this time, firing may be performed while applying a pressure to the mixture by hot pressing or the like. Since silicate is stable at higher than or equal to 450° C. and lower than or equal to 1,000° C. and hardly reacts with silicon, even when the capacity decreases, it is minor. In addition, the carbon precursor is not crystallized at higher than or equal to 450° C. and lower than or equal to 1,000° C. and is in an amorphous state.

(6) The silicate-containing complex is pulverized and classified by an air flow classifier.

### [Non-Aqueous Electrolyte]

The non-aqueous electrolyte contains a non-aqueous solvent and a lithium salt dissolved in the non-aqueous solvent. A concentration of the lithium salt in the non-aqueous electrolyte is, for example, greater than or equal to 0.5 mol/L and less than or equal to 2 mol/L. The non-aqueous electrolyte may contain a known additive.

As the non-aqueous solvent, for example, a cyclic carbonic acid ester, a chain carbonic acid ester, a cyclic carboxylic acid ester, or the like is used. Examples of the cyclic carbonic acid ester include propylene carbonate (PC) and ethylene carbonate (EC). Examples of the chain carbonic acid ester include diethyl carbonate (DEC), ethyl methyl carbonate (EMC), and dimethyl carbonate (DMC). Examples of the cyclic carboxylic acid ester include γ-butyrolactone (GBL) and γ-valerolactone (GVL). These non-aqueous solvents may be used alone or in combination of two or more thereof.

As the lithium salt, for example, a lithium salt of a chlorine-containing acid (LiClO₄, LiAlCl₄, LiB₁₀Cl₁₀, or the like), a lithium salt of a fluorine-containing acid (LiPF₆, LiBF₄, LiSbF₆, LiAsF₆, LiCF₃SO₃, LiCF₃CO₂, or the like), a lithium salt of a fluorine-containing acid imide (LiN(CF₃SO₂)₂, LiN(CF₃SO₂)(C₄F₉SO₂), LiN(C₂F₅SO₂)₂, or the like), a lithium halide (LiCl, LiBr, LiI, or the like), and the like can be used. These lithium salts may be used alone or in combination of two or more thereof.

### [Separator]

For example, a porous sheet having an ion permeation property and an insulation property is used for the separator. Specific examples of the porous sheet include a fine porous thin film, a woven fabric, and a non-woven fabric. As a material of the separator, an olefin-based resin such as polyethylene or polypropylene, cellulose, and the like are preferable. The separator may be a laminate including a cellulose fiber layer and a thermoplastic resin fiber layer formed of an olefin-based resin or the like.

Hereinafter, the present disclosure will be further described with reference to experimental examples, but the present disclosure is not limited to these experimental examples.

### Experimental Example 1

### [Preparation of Silicate-Containing Complex]

Silicon dioxide and lithium carbonate were mixed so that an atomic ratio of Si/Li was 1.05, and the mixture was fired in air at 950° C. for 10 hours to obtain lithium silicate represented by the formula: Li₂O·2.1SiO₂ (x=2.1). The obtained lithium silicate was pulverized so as to have an average particle diameter of 10 μm.

Lithium silicate (Li₂O·2.1SiO₂) having an average particle diameter of 10 μm and raw material silicon (3 N, average particle diameter 10 μm) were mixed at a mass ratio of 50:50, the mixture was filled in a pot (formed of SUS, volume: 500 mL) of a planetary ball mill (P-5, manufactured by FRITSCH GmbH), 24 balls formed of SUS (diameter 20 mm) were put in the pot, a lid was closed, and the mixture was subjected to a compounding treatment at 200 rpm for 50 hours in an inert atmosphere, thereby obtaining Si-containing silicate particles.

The Si-containing silicate particles obtained by the compounding treatment were pulverized and classified by an air flow classifier to obtain Si-containing silicate particles having an average particle diameter of 0.2 μm.

Si-containing silicate particles having an average particle diameter of 0.2 μm were filled in a pot (formed of SUS, volume: 500 mL) of a planetary ball mill (P-5, manufactured by FRITSCH GmbH), the pot was filled with coal tar pitch so that a mass proportion of residual carbon (that is, carbon phase) after firing in the silicate-containing complex was 30%, 24 SUS balls (diameter 20 mm) were placed in the pot, a lid was closed, and the mixture was stirred at 50 rpm for 1 hour in an inert atmosphere.

The mixture obtained by the stirring was fired at 800° C. for 4 hours in an inert atmosphere to obtain a silicate-contain rig complex. The obtained silicate-containing complex was pulverized and classified by an air flow classifier, Thereafter, a silicate-containing complex having an average particle diameter of 12 ur was obtained using a sieve.

A crystallite size of the silicon particle calculated by the Scherrer equation from a diffraction peak attributed to a Si (111) plane by XRD analysis of the silicate-containing complex was 15 nm. In addition, when the composition of the silicate phase was analyzed by the method (high-frequency induction furnace combustion-infrared absorption method, inert gas fusion-non-dispersive infrared absorption method, or inductively coupled plasma atomic emission spectroscopy (ICP-AES)), a Si/Li ratio was 1.05, and a content of Li₂Si₂O₅ measured by Si-NMR was 48 mass %. In addition, when a particle cross section of the silicate-containing complex was observed with an SEM photograph, it was confirmed that in the silicate-containing complex, a plurality of Si-containing silicate particles were dispersed in the carbon phase, and that in the Si-containing silicate particles, a plurality of silicon particles were dispersed in the silicate phase. The particle morphology of the silicate-containing complex observed in the SEM photograph was similar in Experimental Examples 2 to 11 described below.

### [Manufacture of Negative Electrode]

Graphite having an average particle diameter of 22 μm, a silicate-containing complex having an average particle diameter of 12 μm, polyacrylic acid, carboxymethyl cellulose, and styrene butadiene rubber were mixed so that a mass ratio was X:Y:1:1:1

$$X = 97 - Y \\ Y = 4.8 \div ( 1 - mass ratio of carbon phase in silicate - containing complex )$$

Note that a mass ratio of the carbon phase in Experimental Example 1 is 0.3 because the mass proportion of the carbon phase is 30%.

Ion exchanged water was added to the mixture to prepare a negative electrode mixture slurry having a solid content of 50%. The solid content of the slurry is defined by the following equation.

$$Solid content ( \% ) of slurry = ( solid component ( graphite , silicate - containing complex , and the like ) in negative electrode mixture slurry ) \div ( negative electrode mixture slurry mass ) \times 100$$

Next, the negative electrode mixture slurry was applied to both sides of a copper foil by doctor blade method, and the coating film was dried and then rolled, thereby manufacturing a negative electrode in which a negative electrode mixture layer formed on both sides of the copper foil.

### [Manufacture of Positive Electrode]

A lithium transition metal oxide represented by LiNi_{0.88}Co_{0.09}Al_{0.03}O₂, acetylene black, and polyvinylidene fluoride were mixed at a mass ratio of 95:2.5:2.5, and N-methyl-2-pyrrolidone (NMP) was added, and then stirring was performed using a mixer (T.K. HIVIS MIX, manufactured by PRIMIX Corporation), thereby preparing a positive electrode mixture slurry. Next, the positive electrode mixture slurry was applied to a surface of an aluminum foil, and the coating film was dried and then rolled, thereby manufacturing a positive electrode in which a positive electrode mixture layer having a density of 3.6 g/cm³ was formed on both sides of the aluminum foil.

### [Preparation of Non-Aqueous Electrolyte]

LiPF6 was added to a mixed solvent of ethylene carbonate (C) and diethyl carbonate (DEC) at a volume ratio of 3:7 so that a concentration was 1.0 mol/L, thereby preparing a non-aqueous electrolyte.

### [Manufacture of Non-Aqueous Electrolyte Secondary Battery]

A tab was attached to each electrode, the positive electrode and the negative electrode were disposed with a separator interposed therebetween, and these electrodes were spirally wound to produce an electrode assembly. The electrode assembly was placed in a battery exterior body composed of an aluminum laminate film and vacuum-dried at 105° C. for 2 hours, the non-aqueous electrolyte was injected into the battery exterior body, and then the battery exterior body was sealed, thereby manufacturing a battery.

### Experimental Example 2

A battery was manufactured in the same manner as that of Experimental Example 1, except that the pot was filled with coal tar pitch so that the mass proportion of the carbon phase in the silicate-containing complex was 10%.

### Experimental Example 3

A battery was manufactured in the same manner as that of Experimental Example 1, except that the pot was filled with coal tar pitch so that the mass proportion of the carbon phase in the silicate-containing complex was 45%.

### Experimental Example 4

A battery was manufactured in the same manner as that of Experimental Example 1, except that the average particle diameter of the Si-containing silicate particles obtained by the compounding treatment was adjusted to an average particle diameter of 1 μm by pulverization and classification with an air flow classifier.

### Experimental Example 5

A battery was manufactured in the same manner as that of Experimental Example 1, except that the average particle diameter of the Si-containing silicate particles obtained by the compounding treatment was adjusted to an average particle diameter of 6 μm by pulverization and classification with an air flow classifier.

### Experimental Example 6

A battery was manufactured in the same manner as that of Experimental Example 1, except that the average particle diameter of the silicate-containing complex was adjusted to an average particle diameter of 15 μm by pulverization and classification with an air flow classifier and sieving.

### Experimental Example 7

A battery was manufactured in the same manner as that of Experimental Example 1, except that the average particle diameter of the silicate-containing complex was adjusted to an average particle diameter of 8 μm by pulverization and classification with an air flow classifier and sieving.

### Experimental Example 8

A battery was manufactured in the same manner as that of Experimental Example 1, except that the average particle diameter of the silicate-containing complex was adjusted to an average particle diameter of 4 μm by pulverization and classification with an air flow classifier and sieving.

### Experimental Example 9

A battery was manufactured in the same manner as that of Experimental Example 1, except that coal tar pitch was replaced with a phenol resin.

### Experimental Example 10

A battery was manufactured in the same manner as that of Experimental Example 1, except that the average particle diameter of the Si-containing silicate particles obtained by the compounding treatment was adjusted to an average particle diameter of 0.1 μm by pulverization and classification using an air flow classifier.

### Experimental Example 11

A battery was manufactured in the same manner as that of Experimental Example 1, except that the average particle diameter of the Si-containing silicate particles obtained by the compounding treatment was adjusted to an average particle diameter of 0.1 μm by pulverization and classification with an air flow classifier, and the average particle diameter of the silicate-containing complex was adjusted to an average particle diameter of 10 μm by pulverization and classification with an air flow classifier and sieving.

### Experimental Example 12

A battery was manufactured in the same manner as that of Experimental Example 1, except that the Si-containing silicate particles obtained by the compounding treating were used as a negative electrode active material without preparing the silicate-containing complex.

### Experimental Example 13

Silicon dioxide and lithium carbonate were mixed so that an atomic ratio of Si/Li was 1.05, and the mixture was fired in air at 950° C. for 10 hours to obtain lithium silicate represented by the formula: Li₂O·2.1SiO₂ (x=2.1). The obtained lithium silicate was pulverized so as to have an average particle diameter of 10 μm.

Lithium silicate (I₂O·2.1SiO₂) having an average particle diameter of 10 μm and raw material silicon (3 N, average particle diameter 10 μm) were mixed at a mass ratio of 50:50, the mixture was filled in a pot (formed of SUS, volume: 500 mL) of a planetary ball mill (P-5, manufactured by FRITSCH GmbH), 24 balls formed of SUS (diameter 20 mm) were put in the pot, a lid was closed, and the mixture was subjected to a compounding treatment at 200 rpm for 50 hours in an inert atmosphere, thereby obtaining Si-containing silicate particles.

The Si-containing silicate particles obtained by the compounding treatment were pulverized and classified by an air flow classifier to obtain Si-containing silicate particles having an average particle diameter of 12 μm.

Si-containing silicate particles having an average particle diameter of 12 μm were filled in a pot (formed of SUS volume: 500 mL) of a planetary ball mill (P-5, manufactured by FRITSCH GmbH), the pot was filled with coal tar pitch so that a mass proportion of residual carbon after firing in the silicate-containing complex was 4%, 24 SUS balls (diameter 20 mm) were placed in the pot, a lid was closed, and the mixture was stirred at 50 rpm for 1 hour in an inert atmosphere.

The mixture obtained by the stirring was fired in an inert atmosphere at 800° C. for 1 hour to obtain a silicate-containing complex. Thereafter, a silicate-containing complex whose particle size distribution was adjusted using a sieve was obtained. Note that a volume average particle diameter of the obtained silicate-containing complex was comparable to the average particle diameter of the Si-containing silicate particles.

When a particle cross section of the silicate-containing complex of Experimental Example 13 was observed with an SEM photograph, it was confirmed that the silicate-containing complex was a particle in which a carbon film was coated onto a surface of the Si-containing silicate particle in which a plurality of silicon particles were dispersed in a silicate phase.

### [Charge and Discharge Cycle Test]

The battery of each experimental example was subjected to constant current charge at a current of 1 It (800 mA) until a voltage reached 4.2 V, and thereafter, the battery was subjected to constant voltage charge at a constant voltage of 4.2 V until a current reached 1/20 It (40 mA). Next, constant current discharge was performed at a current of 1 It (800 mA) until a voltage reached 2.75 V. A pause period between charging and discharging was set to 10 minutes, and a charge and discharge cycle was repeated 200 cycles to measure a capacity retention rate represented by the following equation.

$$Capacity retention rate ( \% ) = ( discharge capacity at {200}^{th} cycle / discharge capacity at {1}^{st} cycle ) \times 100$$

Table 1 summarizes the results of the capacity retention rate based on the charge and discharge cycle test of each experimental example. Note that the higher the value of the capacity retention rate, the more suppressed the deterioration of the charge and discharge cycle characteristics.

TABLE 1

| | Mass proportion | Carbonaceous | Average particle | Average particle | | |
|---|---|---|---|---|---|---|
| | of residual carbon | material in | diameter (A) of | diameter (B) | Ratio (B/A) | |
| | after firing in | silicate- | Si-containing | of silicate- | of average | Capacity |
| | silicate-containing | containing | silicate | containing | particle | retention |
| | complex/(%) | complex | particles/(μm) | complex/(μm) | diameters | rate/(%) |
| Experimental | 30 | Coal tar pitch | 0.2 | 12 | 60 | 85 |
| Example 1 | | | | | | |
| Experimental | 10 | Coal tar pitch | 0.2 | 12 | 60 | 82 |
| Example 2 | | | | | | |
| Experimental | 45 | Coal tar pitch | 0.2 | 12 | 60 | 86 |
| Example 3 | | | | | | |
| Experimental | 30 | Coal tar pitch | 1 | 12 | 12 | 76 |
| Example 4 | | | | | | |
| Experimental | 30 | Coal tar pitch | 6 | 12 | 2 | 73 |
| Example 5 | | | | | | |
| Experimental | 30 | Coal tar pitch | 0.2 | 15 | 75 | 84 |
| Example 6 | | | | | | |
| Experimental | 30 | Coal tar pitch | 0.2 | 8 | 40 | 86 |
| Example 7 | | | | | | |
| Experimental | 30 | Coal tar pitch | 0.2 | 4 | 20 | 87 |
| Example 8 | | | | | | |
| Experimental | 30 | Phenol resin | 0.2 | 12 | 60 | 83 |
| Example 9 | | | | | | |
| Experimental | 30 | Coal tar pitch | 0.1 | 12 | 120 | 84 |
| Example 10 | | | | | | |
| Experimental | 30 | Coal tar pitch | 0.1 | 10 | 100 | 86 |
| Example 11 | | | | | | |
| Experimental | 0 | — | 0.2 | — | — | 71 |
| Example 12 | | | | | | |
| Experimental | 4 | Coal tar pitch | 12 | ≈12 | ≈1 | 73 |
| Example 13 | | | | | | |

As illustrated in Table 1, the capacity retention rates of Experimental Examples 1 to 3 and 6 to 11 showed high values exceeding 80%. On the other hand, the capacity retention rates of Experimental Examples 4, 5, 12, and 13 were less than 80%, which were values lower than those of Experimental Examples 1 to 3 and 6 to 11. From these facts, it is clear that when a silicate-containing complex containing a carbon phase and a plurality of Si-containing silicate particles dispersed in the carbon phase has a ratio (B/A) of an average particle diameter (B) of the silicate-containing complex to an average particle diameter (A) of the Si-containing silicate particles of greater than or equal to 15 and less than or equal to 120 is used as a negative electrode active material, the Si-containing silicate particle containing a silicate phase and a plurality of silicon particles dispersed in the silicate phase, deterioration of charge and discharge cycle characteristics can be suppressed.

### REFERENCE SIGNS LIST

10 Silicate-containing complex
12 Carbon phase
14 Si-containing silicate particle
16 Silicate phase
18 Silicon particle

1. A negative electrode active material for a non-aqueous electrolyte secondary battery, comprising:
a silicate-containing complex containing a carbon phase and a plurality of Si-containing silicate particles dispersed in the carbon phase,
wherein the Si-containing silicate particle contains a silicate phase and a plurality of silicon particles dispersed in the silicate phase, and
a ratio (B/A) of an average particle diameter (B) of the silicate-containing complex to an average particle diameter (A) of the Si-containing silicate particles is greater than or equal to 15 and less than or equal to 120.

2. The negative electrode active material for a non-aqueous electrolyte secondary battery according to claim 1, wherein the ratio (B/A) of the average particle diameter (B) of the silicate-containing complex to the average particle diameter (A) of the Si-containing silicate particles is greater than or equal to 20 and less than or equal to 120.

3. The negative electrode active material for a non-aqueous electrolyte secondary battery according to claim 1, wherein a content of the carbon phase is greater than or equal to 10 mass % and less than or equal to 45 mass % with respect to a total amount of the silicate-containing complex.

4. The negative electrode active material for a non-aqueous electrolyte secondary battery according to claim 1, wherein the carbon phase is amorphous carbon.

5. The negative electrode active material for a non-aqueous electrolyte secondary battery according to claim 1, wherein the average particle diameter of the silicate-containing complex is greater than or equal to 4 μm and less than or equal to 15 μm.

6. The negative electrode active material for a non-aqueous electrolyte secondary battery according to claim 4, wherein the average particle diameter of the silicate-containing complex is greater than or equal to 4 μm and less than or equal to 8 μm.

7. The negative electrode active material for a non-aqueous electrolyte secondary battery according to claim 1, wherein the average particle diameter of the Si-containing silicate particles is less than or equal to 1 μm.

8. The negative electrode active material for a non-aqueous electrolyte secondary battery according to claim 7, wherein the average particle diameter of the Si-containing silicate particles is less than or equal to 200 nm.

9. A non-aqueous electrolyte secondary battery comprising a negative electrode including a negative electrode mixture layer containing the negative electrode active material for a non-aqueous electrolyte secondary battery according to claim 1, a positive electrode, and a non-aqueous electrolyte.

10. The non-aqueous electrolyte secondary battery according to claim 9, wherein a content of the silicate-containing complex is greater than or equal to 1 mass % and less than or equal to 50 mass % with respect to a total amount of the negative electrode mixture layer.
